(19) United States
(12) Patent Application Publication
(10) Pub. No.: US 2018/0361862 A1
(43) Pub. Date: Dec. 20, 2018

(54) VEHICLE CHARGE-CORD SYSTEM

(71) Applicant: Lear Corporation, Southfield, MI (US)

(72) Inventors: David A. HEIN, Sterling Heights, MI (US); David MENZIES, Linden, MI (US); Mark Anthony MUELLER, Fenton, MI (US); Reinhard PUSCH, Farmington Hills, MI (US)

(73) Assignee: Lear Corporation, Southfield, MI (US)

(21) Appl. No.: 16/060,298

(22) PCT Filed: Feb. 11, 2016
(86) PCT No.: PCT/US16/17439

§ 371 Date: Jun. 7, 2018

(51) Int. Cl. B60L 11/18; H01R 13/66

(52) U.S. Cl. CPC B60L 11/1818; B60L 11/1838; B60L 2240/36; H01R 13/6683; B60L 2230/12; H01R 13/6616

(57) ABSTRACT

A vehicle charge-cord system has a first cord arrangement including a first plug configured for connection to a vehicle electrical inlet. A second cord arrangement includes a second plug configured for connection to a power supply. A control system is configured to receive input power through the second cord arrangement and to provide output power through the first cord arrangement. The control system is further configured to receive information from the second cord arrangement indicative of at least one parameter of the input power, and to output a signal indicative of at least one parameter of the output power based on the information received.

### TECHNICAL FIELD

The present disclosure relates to a vehicle charge-cord system.

### BACKGROUND

With the advent of electric and hybrid electric vehicles, vehicle operators are looking for convenient ways to charge their vehicles, and in particular, more places to charge their vehicles. This has led to the development of portable charge-cord sets that make it possible for the vehicle to be charged at various locations. One issue that has arisen is that the power supply available to charge a vehicle may differ from location to location. In some cases, the power supply voltage may differ significantly between charging locations, while in other situations, the rated current or the frequency of the power being supplied may vary.

Many types of power supplies have outlets with electrical terminal configurations specific to the type of power being supplied. The associated cord sets and other electrical apparatuses that are configured to accept the specific type of power will have matching electrical terminals so that they can be connected to the appropriate power supply outlet. Unfortunately, if a vehicle operator is carrying a charge-cord set configured for use with one type of supply power, and the vehicle is at a charging location where a different type of supply power is available, it may not be possible for the operator to charge the vehicle. It may also not be practical or otherwise economically efficient for a vehicle operator to carry many different types of charge-cord sets in the vehicle just to try to increase the likelihood that they will have available the correct configuration for a power supply which may be encountered. Therefore, a need exists for a vehicle charge-cord system that allows flexibility with regard to the power supplies with which it can be used.

### SUMMARY

At least some embodiments of the present invention include a vehicle charge-cord system that has a first cord arrangement including a first plug configured for attachment to a vehicle electrical inlet. Each of a plurality of second cord arrangements includes a respective second plug configured for attachment to a respective power supply outlet. Each of the second plugs include a terminal arrangement configured to electrically connect to a terminal arrangement in the respective power supply outlet, and at least one of the second plugs has a terminal arrangement that is different from a terminal arrangement of at least one other of the second plugs. A control system is attached to the first cord arrangement and selectively attachable to and detachable from each of the second cord arrangements. The control system is configured to: (i) receive input power through any of the second cord arrangements to which it is attached, and provide output power through the first cord arrangement, (ii) communicate with any of the second cord arrangements to which it is attached to receive control information indicative of at least one parameter of the input power, and (iii) output a signal indicative of at least one parameter of the output power based on the control information received.

At least some embodiments of the present invention include a vehicle charge-cord system that has a first cord arrangement including a first plug configured for connection to a vehicle electrical inlet. A second cord arrangement includes a second plug configured for connection to a power supply. A control system is configured to receive input power through the second cord arrangement and to provide output power through the first cord arrangement. The control system is further configured to receive information from the second cord arrangement indicative of at least one parameter of the input power, and to output a signal indicative of at least one parameter of the output power based on the information received.

At least some embodiments of the present invention include a vehicle charge-cord system that has an output cord arrangement including an output plug configured for attachment to a vehicle. A first input cord arrangement includes a first input plug configured for attachment to a first power supply outlet, and has a first terminal arrangement configured to electrically connect to a terminal arrangement in the first power supply outlet. A second input cord arrangement includes a second input plug configured for attachment to a second power supply outlet, and has a second terminal arrangement configured to electrically connect to a terminal arrangement in the second power supply outlet that is different from the terminal arrangement in the first power supply outlet. A control system is attached to the output cord arrangement and has at least one connector for connecting the control system to the first input cord arrangement and the second input cord arrangement. The control system is configured to receive input power and control information through either of the input cord arrangements that is connected to the at least one connector, and to provide output power through the output cord arrangement. The control system is further configured to output a signal indicative of at least one parameter of the output power based on the control information received.

### BRIEF DESCRIPTION OF THE DRAWINGS

FIG. 1 shows a vehicle charge-cord system in accordance with embodiments of the present invention;

FIG. 2 shows a portion of a vehicle having an electrical inlet that cooperates with an output cord arrangement of the vehicle charge-cord system shown in FIG. 1;

FIG. 3 shows an input cord arrangement associated with the vehicle charge-cord system shown in FIG. 1;

FIG. 4 shows an input cord arrangement associated with the vehicle charge-cord system shown in FIG. 1; and

FIG. 5 shows a schematic representation of some of the elements of the vehicle charge-cord system shown in FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

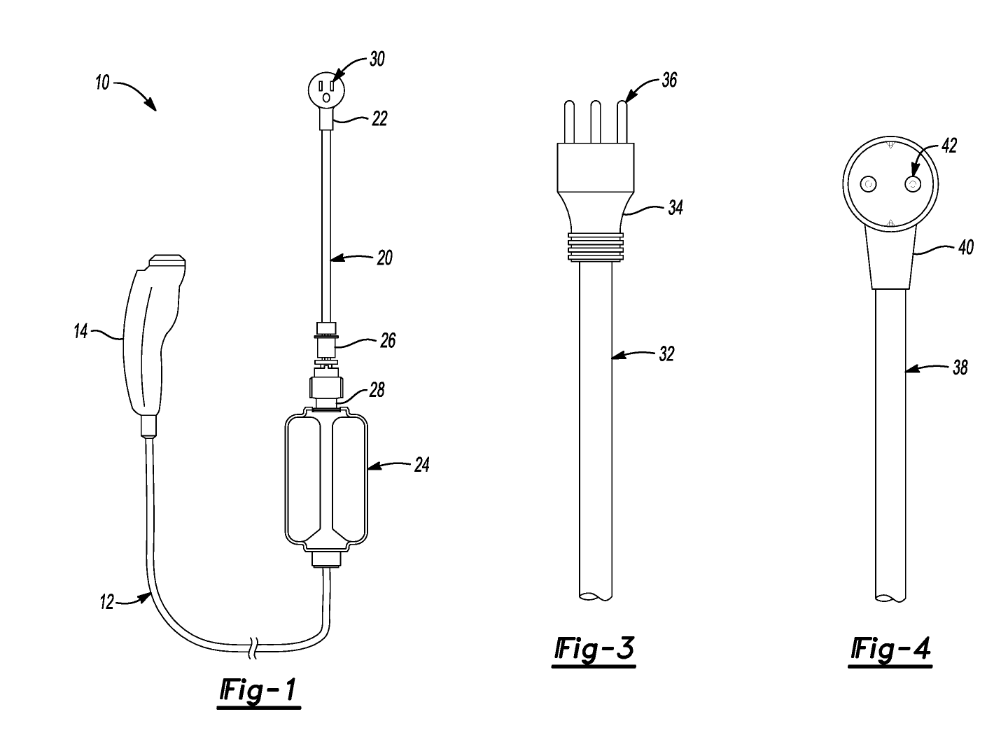

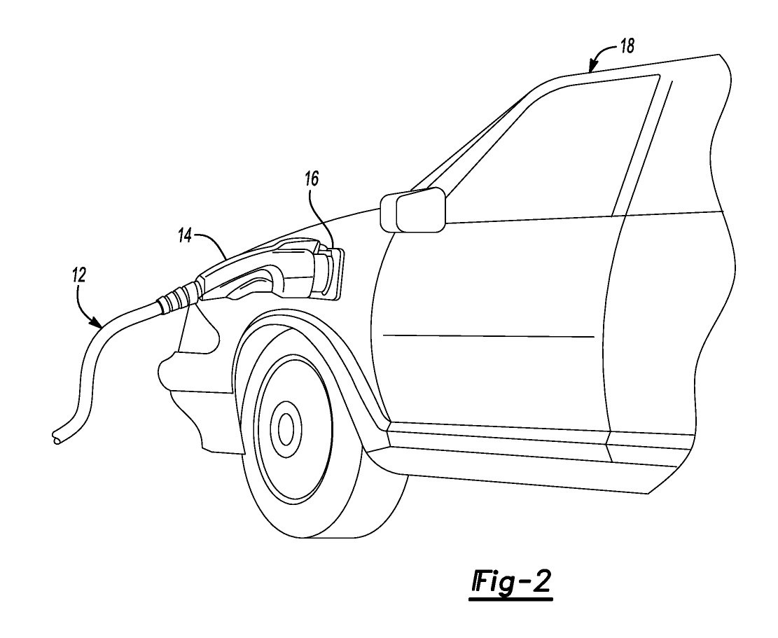

FIG. 1 shows a vehicle charge-cord system 10 in accordance with at least some embodiments of the present invention. The charge-cord system 10 includes a first cord arrangement 12, which includes a first plug 14 configured for attachment to a vehicle electrical inlet, such as the vehicle electrical inlet 16 of the vehicle 18 shown in FIG. 2. The charge-cord system 10 further includes a second cord arrangement 20, which includes a second plug 22, configured for attachment to a power supply. The second plug 22 may be configured to attach to the power supply through a power supply outlet, such as may be found at a charging station or at a residence, for example, in a residential garage.

The charge-cord system 10 also includes a control system 24, illustrated in FIG. 1 as an in-cable control box (ICCB). The second cord arrangement 20 may be conveniently referred to as an input cord arrangement because the control system 24 receives power from a power supply through the second cord arrangement 20. Similarly, the first cord arrangement 12 may be conveniently referred to as an output cord arrangement because the control system 24 outputs power to a vehicle, such as the vehicle 18, through the first cord arrangement 12. For consistency, the second plug 22 may be referred to as an input plug while the plug 14 may be referred to as an outlet plug; however, the output plug 14 may be commonly known as a “charge handle” or by other industry terms.

The second cord arrangement 20 includes an electrical connector 26 for effecting a connection to the control system 24. In the embodiment shown in FIG. 1, the ICCB 24 includes a mating connector 28, which connects to the connector 26 on the second cord arrangement 20. As explained in more detail below, this allows the control system 24 to be selectively attachable to and detachable from the second cord arrangement 20. Also shown in FIG. 1, is a terminal arrangement 30 associated with the second plug 22. In the embodiment shown in FIG. 1, the terminal arrangement 30 is an arrangement of three terminals configured in accordance with a standard United States electrical outlet—e.g., it conforms to a NEMA 5-15 standard. The terminal arrangement 30 on the plug 22 is configured to electrically connect to a terminal arrangement in a power supply outlet through which the charge-cord system 10 will receive power to charge a vehicle.

Embodiments of the present invention may include any number of second cord arrangements—i.e., input cord arrangements—to facilitate charging a vehicle from power supplies having different power characteristics and different terminal configurations associated with their respective power supply outlet. For example, FIG. 3 shows another second cord arrangement 32 having a second plug 34 and an electrical terminal arrangement 36. The cord arrangement 32 may be referred to as a second input cord arrangement, while the cord arrangement 20 is a first input cord arrangement. Alternatively, the cord arrangement 12 was referred to as a first cord arrangement, and the cord arrangement 20 was referred to as a second cord arrangement; therefore, the cord arrangement 32 may be referred to as a third cord arrangement having a third plug 34. Regardless of the nomenclature, embodiments of the present invention allow a number of different input cord arrangements to be attached to and detached from a control system, such as the control system 24.

The terminal arrangement 36 of the cord arrangement 32 is configured in accordance with a Swiss electrical standard, and may be used with power supply outlets also meeting this standard. Similarly, FIG. 4 shows another second cord arrangement 38 having a second plug 40 and an electrical terminal arrangement 42 meeting a European Union electrical standard. Although not shown in FIGS. 2 and 3, it is understood that the second cord arrangements 32, 38 will each include an electrical connecto—such as the electrical connector 26 shown in FIG. 1, and disposed at an end opposite the second plug 36, 42, so that each of them may be selectively connectable to the control system 24. Although the control system 24 is illustrated in FIG. 1 with a single electrical connector 28, which means that only one of the input cord arrangements 20, 32, 38 can be connected to it at any given time, embodiments of the present invention may include a control system having more than one connection capability to accommodate multiple input cord arrangements connected to it simultaneously.

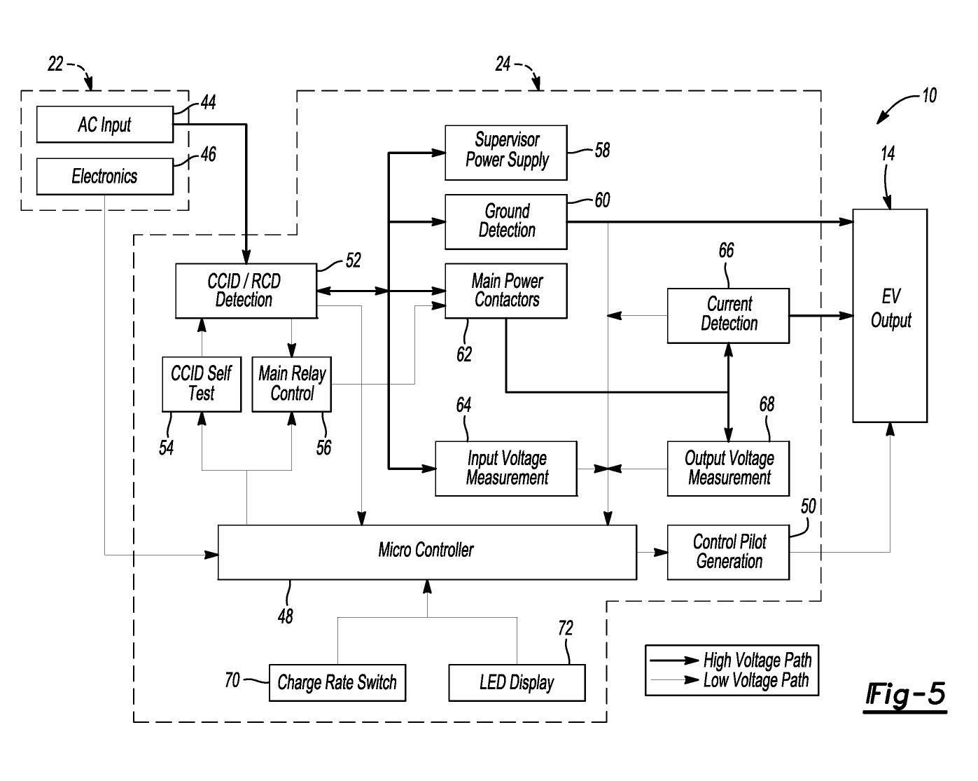

FIG. 5 shows a schematic representation of the charge-cord system 10 shown in FIG. 1. In general, the control system 24 is configured to receive input power through any of the second cord arrangements 20, 32, 38 to which it is attached. It then provides output power through the first cord arrangement 12 to a vehicle, such as the vehicle 18 shown in FIG. 2. As explained in more detail below, the control system 24 communicates with any of the second cord arrangements to which it is attached to receive specific information—which may be conveniently referred to as “control information”—indicative of at least one parameter of the input power. The control system is further configured to output a signal indicative of at least one parameter of the output power based on the control information received through the input cord arrangement.

As described above, embodiments of the present invention may provide a number of advantages, including the ability to use different input cord arrangements with the same output cord arrangement and control system. Because the input power may differ between different charging stations, embodiments of the present invention are configured to accept a variety of power inputs and provide appropriate outputs to a vehicle. For example, the at least one parameter of the input power described above, may include at least one of a voltage, current or frequency of the input power. Any or all of these input power parameters may be compared to a desired range or limits, and the control system 24 may take actions in accordance with the information received.

In order for the control system 24 to take appropriate actions, it may be necessary for it to communicate with the particular input cord arrangement to which it is attached and which is attached to a power supply. One way in which the control system 24 may communicate with and receive information from the input cord arrangement 20, is by determining something about the configuration of the input cord arrangement 20; this in turn will provide information to the control system 24 indicative of at least one parameter of the expected input power. In the embodiment shown in FIG. 5, the input plug 22 is shown having two distinct components: AC Input 44 and Electronics 46. It is understood that the schematic representation shown in FIG. 5 is a high-level schematic, and that any of the blocks in the diagram may represent any number of smaller components or systems connected to and interacting with each other.

The block illustrated as Electronics 46 may represent any number of different types of components or systems, including, for example, a temperature sensor system. In such embodiments, a temperature sensor can measure a temperature at a power supply outlet into which the plug 22 is connected. The temperature sensor can then send a signal to the control system 24, and more particularly, to a Micro Controller 48 for processing. If the measured temperature is outside of some range, or is above some high limit—e.g., a predetermined temperature limit—the control system 24 may at least limit the output power through the output cord arrangement 12 so that the temperature does not continue to increase. Thus, the control system 24 may reduce the output power, for example, by modifying a duty cycle for a charging process of the vehicle 18. This may be facilitated, for example, by the Micro Controller 48 controlling the Control Pilot Generation 50, which then sends a signal directly to the EV Output, or output plug 14. Alternatively, the control system 24 may completely prohibit the output power from reaching the output plug 14 if the temperature is too high.

Turning now to the electrical power and how it is processed by the control system 24: the AC Input 44 provides power through the input plug 22 to a CCID/RCD Detection block 52. The Charge Circuit Interrupt Device (CCID) and the Residual Current Device (RCD) detection at block 52 provides a system for interrupting the flow of current where it is outside of a predetermined parameters. The CCID Test 54 and the Main Relay Control 56 support the CCID/RCD Detection at block 52, and are both in communication with the Micro Controller 48. A Supervisor Power Supply 58, Ground Detection 60, Main Power Contactors 62, and an Input Voltage Measurement 64 all receive power from or provide power to the CCID/RCD Detection block 52. Provided that the appropriate ground is detected at block 60, power is allowed to pass through to the output plug 14. Similarly, when the Main Power Contactors 62 receive power, and an appropriate signal from the Main Relay Control 56, they will close to allow power to pass through to a Current Detection module 66 and an Output Voltage Measurement module 68. In the embodiment shown in FIG. 5, the control system 24 also includes a Charge Rate Switch 70 and an LED Display 72, each of which communicates directly with the Micro Controller 48.

Returning to the low-voltage side of the control system 24, the determination of parameters associated with the input power is now described. As described above, the Electronics 46 may include such things as a temperature detection system facilitating thermal protection of the charge-cord system 10 and associated electrical components. In at least some embodiments of the present invention, the Electronics 46 disposed within the input plug 22 may include a resistor having a predetermined resistance associated with the input power that the input cord arrangement—for example any of the input cord arrangements 20, 32, 38—was configured to accept. For example, the input cord arrangement 20 shown in FIG. 1 may include a resistor having a first predetermined resistance of 150 ohms, the value of which can be communicated to the control system 24 when the input cord arrangement 20 is attached to it and the input plug 22 is attached to a power supply outlet.

The control system 24, and in particular the Micro Controller 48, may be preprogrammed with software that associates a particular resistance value for the resistor with a particular input power. Continuing with the example from above, when the input cord arrangement 20 is attached to the control system 24, and the control system 24 determines that the input cord arrangement 20 includes a resistor having a resistance value of 150 ohms, the control system 24 will know that it should expect the type of power associated with a NEMA 5-15 plug—i.e., power with a rating of 15 amperes and 125 volts.

Similarly, the input cord arrangements 32, 38 may each include resistors having different resistance values—e.g., second and third predetermined resistances—because they are each configured with input plugs 36, 42, which are configured to receive power having different characteristics from the power associated with the input cord arrangement 20. For example, the second and third predetermined resistances may be 210 ohms and 290 ohms, respectively. Although particular resistance values were provided in the examples above, embodiments of the present invention may use resistors having different resistance values, and in general may have any resistance value effective to meet the design goals. Thus, the resistors used in the input cord arrangements may be considered “coded resistors”, since they provide information to the control system 24 about the type of power that should be received through the input cord arrangement. As described above, this information may be conveniently called “control information”, and may include any of a variety of parameters associated with the input power, such as frequency, voltage, current, or all of them.

Although the coded resistors are described as being disposed within the input plugs of the input cord arrangements 20, 32, 38, the coded resistors could be located in other parts of the input cord arrangement, such as in a connector like the connector 26 shown in FIG. 1. Once the Micro Controller 48 receives the information related to the input power, it provides a signal indicative of at least one parameter of the output power based on the information it receives. As described above, this may include a signal to the Control Pilot Generation 50 to allow a normal duty cycle for the expected input power, it could be a signal to only allow a modified duty cycle for the expected input power, or it could be a signal to indicate that the parameters of the input power are so unexpected or out of range that no charging should be allowed to take place. The Control Pilot Generation 50 then communicates this information to a vehicle, such as the vehicle 18 shown in FIG. 1 through the output plug 14. Electric vehicles typically include onboard charging electronics, which receive and output information related to the charging cycles through a vehicle charge handle, such as the charge handle 14.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle charge-cord system, comprising:
a first cord arrangement including a first plug configured for attachment to a vehicle electrical inlet;
a plurality of second cord arrangements, each including a respective second plug configured for attachment to a respective power supply outlet, each of the second plugs including a terminal arrangement configured to electrically connect to a terminal arrangement in the respective power supply outlet, and at least one of the second plugs having a terminal arrangement that is different from a terminal arrangement of at least one other of the second plugs; and
a control system attached to the first cord arrangement and selectively attachable to and detachable from each of the second cord arrangements, the control system being configured to:
receive input power through any of the second cord arrangements to which the control system is attached, and provide output power through the first cord arrangement,
communicate with any of the second cord arrangements to which the control system is attached to receive control information indicative of at least one parameter of the input power, and
output a signal indicative of at least one parameter of the output power based on the control information received.

2. The vehicle charge-cord system of claim 1, wherein the at least one parameter of the input power includes an input power current.

3. The vehicle charge-cord system of claim 2, wherein the at least one parameter of the output power is an output power current.

4. The vehicle charge-cord system of claim 1, wherein each of the second cord arrangements further includes a resistor having a respective predetermined resistance, and the control information provides to the control system a value of the predetermined resistance.

5. The vehicle charge-cord system of claim 4, wherein each of the resistors is disposed in a respective second plug.

6. The vehicle charge-cord system of claim 5, wherein each of the second cord arrangements further includes a respective electrical connector for effecting a connection to the control system, and each of the resistors is disposed in a respective electrical connector.

7. The vehicle charge-cord system of claim 1, wherein the at least one parameter of the input power includes at least one of a voltage, current or frequency of the input power.

8. The vehicle charge-cord system of claim 7, wherein each of the second plugs includes a temperature sensor for measuring a temperature at a power supply outlet into which it is attached and sending a signal to the control system indicative of the temperature measured.

9. The vehicle charge-cord system of claim 8, wherein the control system is further configured to at least limit the output power through the first cord arrangement when the at least one parameter of the input power is outside a respective predetermined limit or the temperature measured is outside a predetermined temperature limit.

10. A vehicle charge-cord system, comprising:
a first cord arrangement including a first plug configured for connection to a vehicle electrical inlet;
a second cord arrangement including a second plug configured for connection to a power supply; and
a control system configured to receive input power through the second cord arrangement and to provide output power through the first cord arrangement, the control system being further configured to receive information from the second cord arrangement indicative of at least one parameter of the input power, and to output a signal indicative of at least one parameter of the output power based on the information received.

11. The vehicle charge-cord system of claim 10, further comprising a third cord arrangement including a third plug configured for connection to a power supply different from the power supply to which the second plug is configured to connect, each of the second and third cord arrangements being attachable to and detachable from the control system.

12. The vehicle charge-cord system of claim 11, wherein the second cord arrangement further includes a resistor having a first predetermined resistance, and the information received by the control system includes a value of the first predetermined resistance.

13. The vehicle charge-cord system of claim 12, wherein the third cord arrangement further includes a resistor having a second predetermined resistance different from the first predetermined resistance, and the information received by the control system includes a value of the second predetermined resistance.

14. The vehicle charge-cord system of claim 10, wherein the second cord arrangement further includes an electrical connector for effecting a connection to the control system, and a resistor having a first predetermined resistance and disposed in one of the second plug or the electrical connector.

15. The vehicle charge-cord system of claim 10, wherein the at least one parameter of the input power includes an input power current and the at least one parameter of the output power is an output power current.

16. The vehicle charge-cord system of claim 10, wherein the signal output by the control system defines a duty cycle for a charging process.

17. The vehicle charge-cord system of claim 10, wherein the second plug includes a temperature sensor for measuring a temperature at a power supply outlet into which the second plug is attached and sending a signal to the control system indicative of the temperature measured.

18. A vehicle charge-cord system, comprising:
an output cord arrangement including an output plug configured for attachment to a vehicle;
a first input cord arrangement including a first input plug configured for attachment to a first power supply outlet and having a first terminal arrangement configured to electrically connect to a terminal arrangement in the first power supply outlet;
a second input cord arrangement including a second input plug configured for attachment to a second power supply outlet and having a second terminal arrangement configured to electrically connect to a terminal arrangement in the second power supply outlet that is different from the terminal arrangement in the first power supply outlet; and
a control system attached to the output cord arrangement and having at least one connector for connecting the control system to the first input cord arrangement and the second input cord arrangement, the control system being configured to receive input power and control information through either of the input cord arrangements that is connected to the at least one connector, and to provide output power through the output cord arrangement, and further configured to output a signal indicative of at least one parameter of the output power based on the control information received.

19. The vehicle charge-cord system of claim 18, wherein the first input cord arrangement further includes a resistor having a first predetermined resistance, and the second input cord arrangement further includes a resistor having a second predetermined resistance different from the first predetermined resistance, the control information providing to the control system a value of the first predetermined resistance when the first input cord arrangement is connected to the at least one connector and a value of the second predetermined resistance when the second input cord arrangement is connected to the at least one connector.

20. The vehicle charge-cord system of claim 18, wherein the at least one parameter of the input power includes at least one of a voltage, current or frequency of the input power.
